(19) United States
(12) Patent Application Publication
(10) Pub. No.: US 2011/0302005 A1
(43) Pub. Date: Dec. 8, 2011

(54) FRAMEWORK FOR PROMOTIONS

(75) Inventors: Eric Keith Schmitter, Chula Vista, CA (US); Robert E. Bamford, San Diego, CA (US); Akihiko Kusumoto, San Diego, CA (US); Corey Leamon, San Marcos, CA (US); Jason M. Abulencia, San Diego, CA (US); Brian Hostler, San Diego, CA (US); Richard L. Smith, JR., San Diego, CA (US); Aaron Valdes, San Diego, CA (US); Christian Rosa, Escondido, CA (US); Steven Wagner, Alpine, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/156,091

(22) Filed: Jun. 8, 2011

Related U.S. Application Data
(60) Provisional application No. 61/352,733, filed on Jun. 8, 2010.

(51) Int. Cl. G06Q 30/00

(52) U.S. Cl. 705/14.1

(57) ABSTRACT

A system and method that provide a framework or tool through which e-commerce store owners may build promotional packages for e-commerce, and the same acts as a promotion engine or kit for promotions or incentives. In one implementation, a network platform provides a promotion framework that allows storefront managers to create a variety of different types of product offerings.

### CROSS-REFERENCE TO RELATED APPLICATIONS

This application claims benefit of priority to U.S. Provisional Patent Application Ser. No. 61/352,733, filed Jun. 8, 2010, entitled “Promotion Engine”, assigned to the assignee of the present application and herein incorporated by reference in its entirety.

### BACKGROUND

The idea of promotions is very well known, and implementation of the same within e-commerce is practically as old as e-commerce itself. However, current promotions tend to be ad hoc or otherwise the product of custom design. Consequently, there is generally no convenient way to allow storefront managers to easily and conveniently implement new promotions.

### SUMMARY

Implementations of the present system and method provide a framework or tool through which e-commerce store owners may build promotional packages for e-commerce, and the same acts as a promotion engine or kit for promotions or incentives. In one implementation, a network platform provides a promotion framework that allows storefront managers to create a variety of different types of product offerings.

Generally, the system works in two parts: the first part is a promotion or promo portion, through which a store manager can create a purchasable promotion type. The purchasable promotion may be embodied in a voucher, which may be sold, given away, or used as the basis for a marketing effort. In essence, the voucher is a mechanism that conveys an entitlement to a user. The promo portion may also include qualification criteria for reception of the reward portion. The second part is a reward portion, which is also created by the store manager from a set of consumable content. By performing some action with the group X goods, e.g., purchasing one or more, the system allows access to one or more group Y goods.

The group X and the group Y may be entirely coincident, may have a finite intersection, or may have no items in common Besides performing some action with the group X goods, a different condition may be employed by a store manager to determine if a user obtains access to a group Y good, e.g., a subscription status, a score achieved in a game that is a group X product, by purchasing a certain number of goods X over time, as a customer reward for loyalty which may in turn be consumed or gifted, or the like. In a so-called “Pick-N” promotion, a user generally purchases one or more goods or services from one source and thereby becomes entitled to receive another set of goods or services from the same or a different source. The rewarded items may be termed “picks”.

In the framework of the promotion tool, a store manager sets up the groups of goods X and Y, along with parameters for each, which may be associated with their SKUs. The store manager may also place limitations on the access to group Y goods via group X goods, e.g., by way of a rules engine or module. After a user obtains access to the group X and Y goods, the framework may provide for delivery or may direct that delivery be performed.

By associating the goods with SKUs, a degree of reuse may be had of existing tools, commerce system interfaces, and entities for storefronts. To the extent group X and Y goods are tied to entitlements, device bindings to the goods may be effected by way of modifications of certain internal interfaces. For example, a portable gaming system may be tied to an entitled product by way of such an interface, and this tying may be required by the license to the product or by other considerations.

In one aspect, the invention is directed towards a framework, embodied on a non-transitory computer-readable medium, for developing promotions within a network. The framework includes a database module, the database module including a plurality of entities, the entities representing respective goods and services; a promotion pool selection module, the promotion pool selection module configured to receive a user selection of promotion entities from the database module, an aggregate of the selected promotion entities constituting a promotion pool; a reward pool selection module, the reward pool selection module configured to receive a user selection of reward entities from the database module, an aggregate of the selected reward entities constituting a reward pool; and a rules module, the rules module for creating rules that govern entitlement to reward entities upon purchase of promotion entities, the rules module further for determining if a purchase creates an entitlement to a selection from the reward pool.

Implementations of the invention may include one or more of the following. The at least one promotion entity and at least one reward entity may be associated with a respective promotion and reward SKU. The framework may further comprise a commerce system interface, where the commerce system interface accesses one or more promotion or reward SKUs. The promotion pool and the reward pool may be partially or totally coincident. The framework may further comprise a voucher creation module, where a voucher may be created that conveys an entitlement. The voucher may include a coupon code. The voucher creation module may be configured to create a selective voucher, where a selective voucher is a voucher that references a selective entitlement SKU. The selective entitlement SKU may entitle a customer to select a predetermined number of reward entities to receive upon redemption. The selective entitlement SKU may be a recurring selective entitlement SKU, where the selective entitlement SKU renews or is reissued on a periodic basis. The promotion SKU may include one or more parameters about the reward entity. The one or more parameters may be selected from the group consisting of: a recurrence of the promotion, a combinability of the promotion, a number of times the promotion can be consumed and a corresponding consumption counter, a SKU entitlement, and a number of selections that a user may select from the reward pool. The reward SKU may include one or more parameters about the reward entity. The one or more parameters may be selected from the group consisting of: a scope of the reward and an amount of discount to be applied to a reward entity. The rules module may include rules about how many promotion entities need be purchased to create an entitlement to one or more reward entities. The rules module may further include rules about what type of promotion entities need be purchased to create an entitlement to one or more reward entities. The rules module may further include rules about where the promotion entities need be purchased from to create an entitlement to one or more reward entities. The framework may further include a user interface, where a user may control the respective modules. The framework may further include a device bindings module, where a user may control to which category of device a promotion or reward entity is bound. The framework may further include a device bindings module, where a user may control to which device a promotion or reward entity is bound. The promotion or reward entity may constitute a rental.

In another implementation, the invention is directed to a non-transitory computer readable medium, comprising instructions for causing a computing device to implement the above framework.

In a further implementation, the invention is directed towards a method of creating a promotion in an e-commerce system, including: receiving a selection of promotion entities from a database, an aggregate selection constituting a promotion pool; receiving a selection of reward entities from a database, an aggregate selection constituting a reward pool; and developing one or more rules that govern entitlement to reward entities upon purchase of promotion entities, the rules for determining if a purchase creates an entitlement to a selection from the reward pool. In yet another implementation, the invention is directed to a non-transitory computer readable medium, comprising instructions for causing a computing device to implement the above framework.

Implementations of the system and method may be advantageous in a number of ways, including in that a framework or tool is provided that standardizes the creation and operation of promotions. The system and method may provide new ways of selling items, e.g., digital items, in order to maximize revenue to sellers while supplying value to consumers. The system and method may provide fine-grained control over the licensing of content obtained from a reward pool. The platform and framework provides significant control over the details of promotions, allowing store managers to better serve customers. Store managers may be provided business intelligence reports of selective entitlement purchases in order to determine the best bundling and marketing options for future sales opportunities. Managers may moreover conveniently receive financial reconciliation reports of selective entitlement purchases so that they can balance their books and pay appropriate royalties to third-party service providers. By grouping collections of categories and products by way of SKUs into qualification and reward pools, existing tools and interfaces may be re-used for category browsing and management, structure and organization may be simplified, and pools may be populated and presented in the same way as current storefront categories.

### BRIEF DESCRIPTION OF THE DRAWINGS

FIGS. 1(A) and 1(B) illustrate schematic representations of exemplary promotions that may be constructed by way of the framework.

FIGS. 2(A)-(C) illustrate various intersections of promotion and reward pools.

FIG. 3 illustrates an exemplary framework according to the principles described here.

FIG. 4 is a flowchart illustrating an exemplary method according to the principles described here.

FIG. 5(A)-(B) illustrate various types of promotions that may be offered according to the principles described here.

FIG. 6 is a flowchart illustrating another exemplary method according to the principles described here.

FIG. 7 illustrates an exemplary computing device that may be employed to implement the framework.

FIG. 8 illustrates another exemplary computing device that may be employed to implement the framework.

### DETAILED DESCRIPTION

In implementations of the invention according to the principles described here, a promotion is a way of offering goods and/or services that provides incentives to customers to purchase. A promotion links criteria/behavior, governed by a set of rules, to a gift or reward. If the customer satisfies the criteria, he or she is entitled to the gift/reward.

Generally, in the implemented systems, the framework works in two parts: a promotion portion and a reward portion.

### Promo Portion

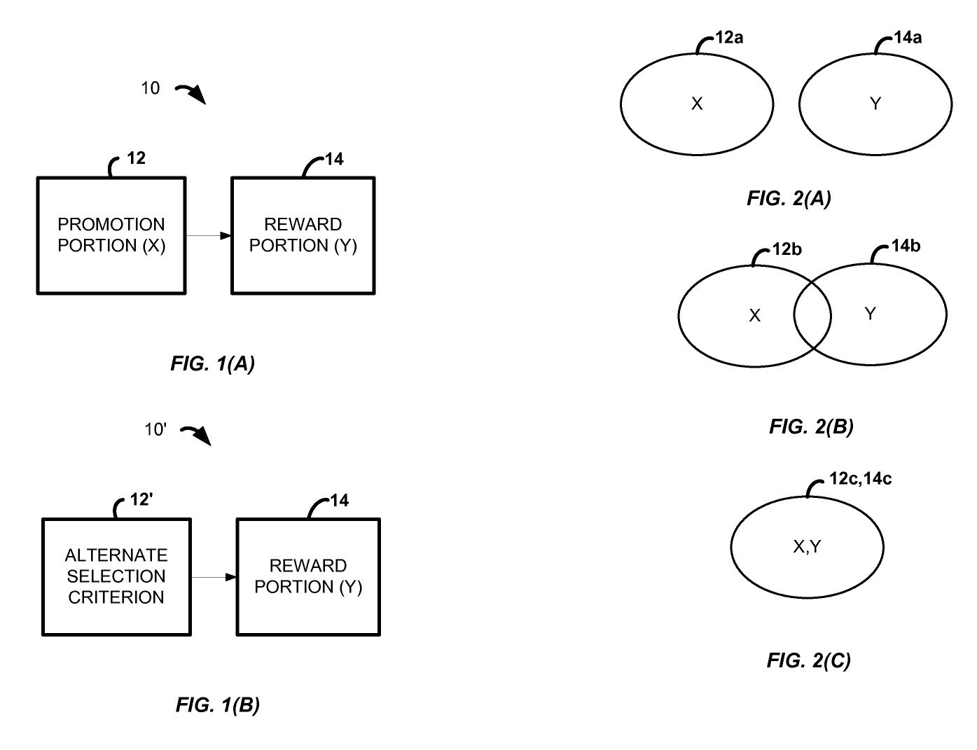

Referring to FIG. 1(A), a promotion 10 has a first part that is a promo portion 12, which in some cases may be embodied in a voucher, which may be sold, given away, or used as the basis for a marketing effort. In essence, a voucher is a mechanism that is instituted to convey an entitlement to a user, and may be embodied as a coupon code or the like.

Product information contained in a promo item or entity may include a promotion name, a short description, a long description, a creation date, a last modified date, a geographical region in which the promotion is active, and a promo SKU (“stock keeping unit”), also termed “parent SKU”, which contains the reward entitlement limits, the same setting details such as the recurrence of the promotion and the limit of “picks” that a user may select from a reward pool, especially where the tool is employed to construct a promotion such as the “Pick-N” promotion described below. Promo SKUs may be generated from modified product SKUs of a group of goods to arrive at a promotion pool. Other information within the SKU may include combinability, i.e., whether the promotion can be used with other promotions, as well as a maximum number of times the promotion can be consumed, and a corresponding consumption counter, which counts down from the maximum. Other information may also be included, as dictated by the requirements of the promotion.

### Reward Portion

The second part is the reward portion 14. A reward entitlement from the reward pool is granted by purchasing a promotion SKU which grants such entitlements or by consuming a promotion voucher referencing such a SKU. In this way, performing some action with the group X goods, e.g., purchasing one or more from the promotion pool, the system may allow access to one or more group Y goods, i.e., from the reward pool.

The reward portion may be represented as a combination of a consumable entitlement, a discount, and a reward selection pool. The consumable entitlement is the right to purchase or do something, and is consumed upon use. For example, the consumable entitlement may be the right to purchase a certain quantity of a given product from a particular vendor for some amount. The discount may be handled in a number of ways, including by linking the discount to a user, a user's shopping cart, or an item to be placed in a user's cart.

The reward information may contain fields such as an identifier, the name of the reward or entitlement by language, the geographic region, an identifier for the entitlement, the name of the reward, a creation date, a modification date, and so on. The reward information may also include information about the amount of discount to be applied to reward items, including a 100% discount for items that are provided free of charge. Four partially discounted items, the reward information may include information about the scope of the reward, e.g., whether the same corresponds to a certain quantity of items or to all items.

The reward pool may be constructed with the framework as a root category that lists all rewards or entitlements available for selection based upon the purchase of a promotion SKU, and may further contain information about categories, products, SKUs, and the same may be formed using existing categories or via extension of existing categories. That is, each pool may constitute a category, and all contents of the pool may be sub elements of the pool category.

The promo and reward pools, e.g., the group X and Y categories, may be static or dynamic. A static group may stay the same until the store manager effects a change, while a dynamic group may change on the fly, according to rules determined by the store manager, such as to reflect changes caused by certain items being placed in a shopping cart, changes caused by a user's subscription status, or the like.

Referring to FIG. 1(B), an alternate promotion 10′ is illustrated in which an alternate selection criterion 12′ is employed to yield a reward portion 14 to a customer. The alternate selection criterion 12′ may be, e.g., a certain number of purchases over time, a subscription status, a score achieved in a game within group X, a loyalty reward, or the like.

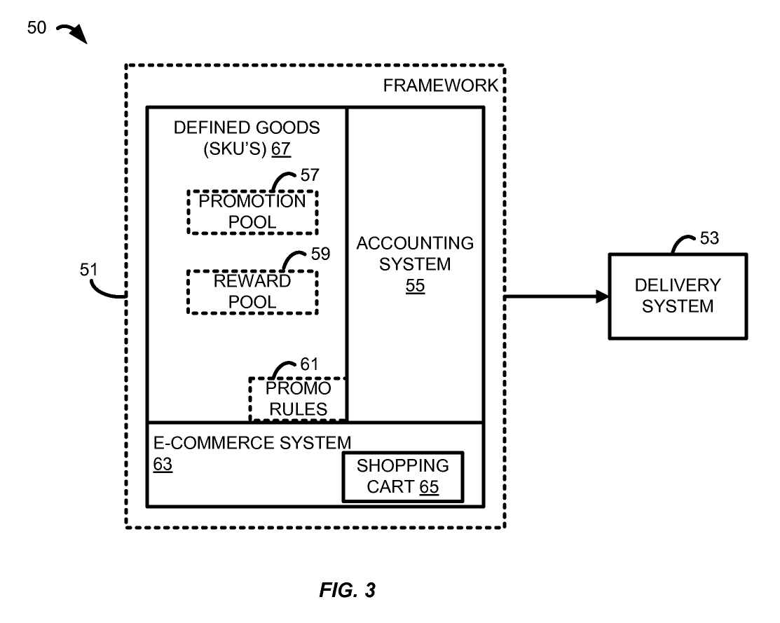

As seen in FIG. 2(A)-(C), the group X and the group Y may be entirely coincident (pools 12a and 14a of FIG. 2(A)), may have a finite intersection (pools 12b and 14b of FIG. 2(B)), or may have no intersection (pools 12c and 14c of FIG. 2(C)). In this way, the framework conveniently allows for cases in which product purchases entitle the purchaser to additional like products (“Buy one get one free!”) or to different products.

### Rules

Rules, such as may be embodied in a ruleset or list of rules (to encompass a number of possibilities), determine if a given customer purchase qualifies for a promotion. The customer may generally be aware of the rules, but the ruleset or list of rules, as embodied in a rule module within the framework, may be employed to test purchases to determine if they objectively qualify for a reward entitlement. As such, rules are often triggered by purchases or other expenses. Upon qualification for a reward entitlement, a voucher may be generated and delivered to the customer, or the customer may be given an immediate opportunity to redeem the entitlement picks.

A rules list can be processed by a rules engine or module within the framework, and may include grouped lists of rules for customers to satisfy to be eligible or to qualify for the gift or reward. For example, a number of items selected must meet the minimum selection count of SKUs, and the SKUs need often be from one or more of a set of specified categories or products, and/or must be from SKUs specified. Rules may be embodied in SKUs. For example, a promo SKU may provide information about the reward portion in fields such as SKU entitlements. Such reward information may include name and quantity, duration, and number of uses. Rules may also dictate SKU eligibility, which determines if an account is able to purchase a product and receive entitlements.

The framework may allow the construction of rules to address partial consumption. For example, a user may consume two of three entitlement selections. The remaining selection may be allowed to be consumed by a friend, or the friends can be enabled to split the cost of a selective voucher and both friends may then receive separate items.

### General Framework Aspects and Methods

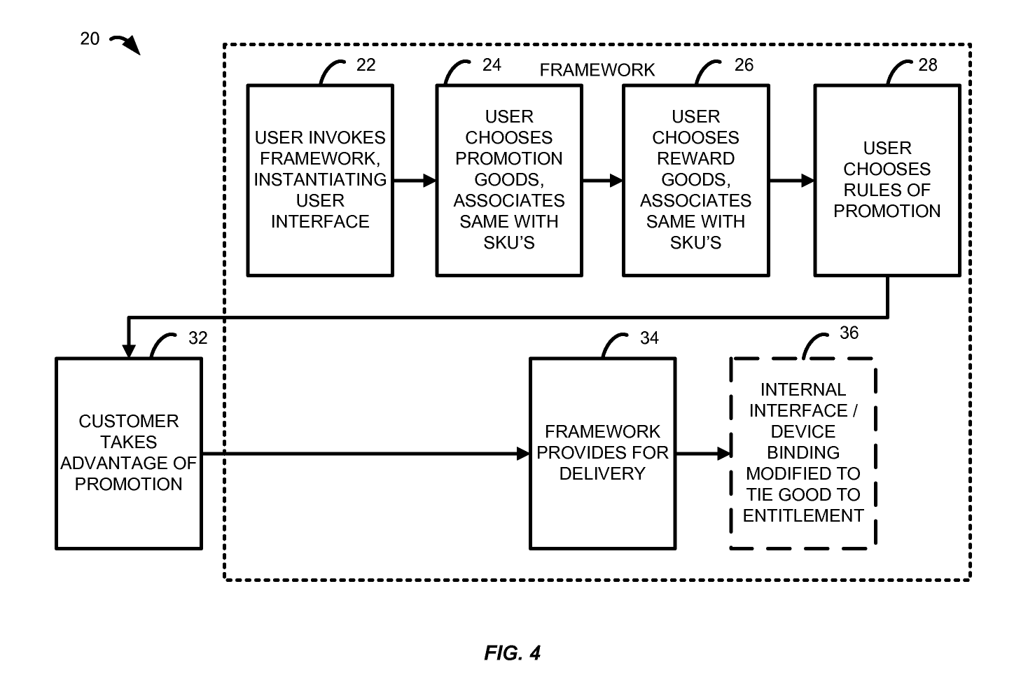

Referring to the system 50 of FIG. 3, a store manager may use a framework 51 to set the group X goods, i.e., the promotion pool 57, to set the group Y goods, i.e., the reward pool 59, and to place limitations on access to the latter via the former via the rules module 61. It is noted in this regard that the promotion and rewards entities may be drawn from a database of defined goods 67. Using the framework of the tool, a store manager obtains access to the group X goods, which are identified by their SKUs. The framework then allows the group Y goods to be identified by their SKUs as reward goods. Generally, purchasing one or more group X goods allows a user to obtain access to one or more group Y goods. Generally, the number of group X goods may differ from the number of group Y goods.

Other aspects of e-commerce may be in place to provide complete functionality. For example, an accounting system 55 may be in place to provide the inventory of such goods. An e-commerce system 63 is generally in place to allow for the purchase of such goods, including tools such as shopping carts 65 and the like.

As noted above, after a user obtains access to the group X and Y goods, the framework may provide (or work with) a delivery system 53 for delivery or may direct that delivery be performed separately. In many cases, such products are provided via digital delivery. Commonly, though not exclusively, a separate set of servers may be provided to house digital content items, and the same may be directed to deliver the content upon direction by a storefront.

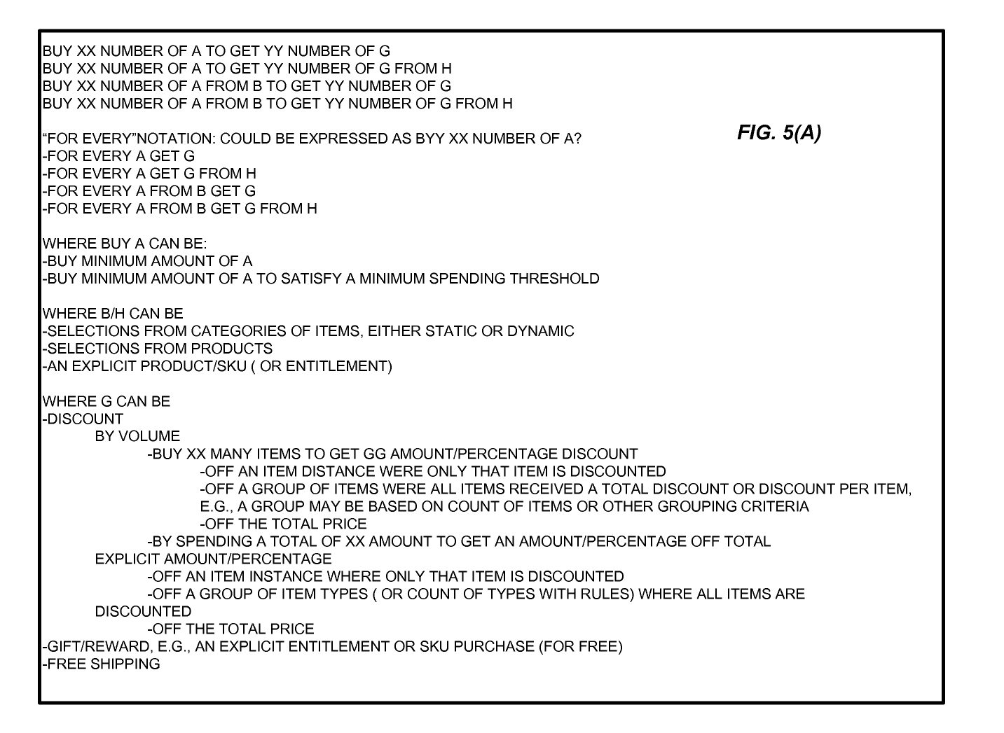

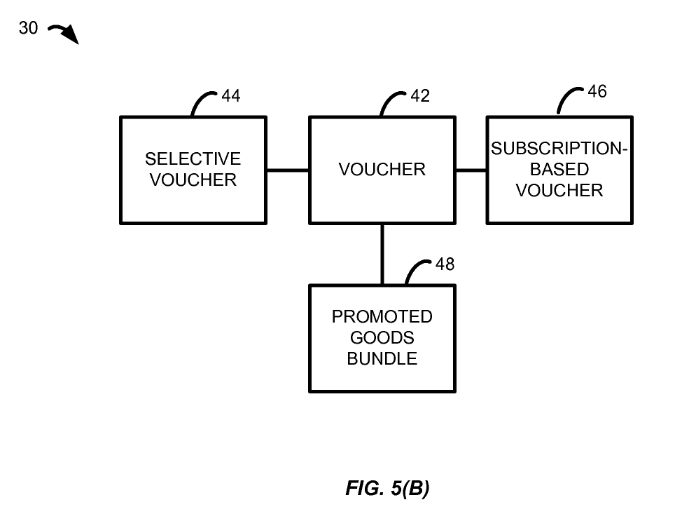

In one implementation of a method according to the principles described here, as illustrated by flowchart 20 of FIG. 4, a first step is that a user invokes a framework, instantiating a user interface (step 22). Employing the same, a user chooses the promotion goods, and in many cases associates the same with SKUs (step 24). A user then chooses the reward goods, and again in many cases associates the same with SKUs (step 26). A user then sets the rules of the promotion (step 28), and in some cases sets these by choosing preset ones from a list. Some types of listed rules are shown in FIG. 5(A). The rules of the promotion may be embodied or implemented in a rules list, or in some cases may form part of the promotion or reward SKU, or both.

Once the promotion is live as part of an active storefront, a customer may take advantage of the promotion (step 32). The reward entitlement may be given directly, by prompting the user for products to be provided as rewards, or the user may be given a voucher entitling the user to redeem the voucher at a later time for the rewarded or entitled products.

The framework may provide for delivery (step 34). In many cases, where the product is a digital good, the delivery may be immediate to the user's system. The delivery may be from the computing device operating the framework, or delivery may be effected from another computing device, e.g., a fulfillment server. Delivery need not be to the device that performed the transaction, e.g., a user may purchase a console game using their PC. In such cases, delivery may be performed when the console is next available and online.

Especially where delivery is to devices such as consoles or portable gaming units, the delivered good may be bound to the device by way of modification of an internal interface (step 36). Similarly, such device bindings may be employed to tie the delivered good to the entitlement itself. Other details of device bindings are noted below.

In constructing any given promotion, a store manager may typically set one or more of the variables above in an appropriate user interface. For example, a store manager may set a promotion ID, a promotion tax code, a revision status, a notation of which devices may see the promotion, as well as details of the promotion name, a short description, a long description, and the like. A store manager may search for prior related SKUs, e.g., by title or licensed content, and new SKUs may be based on these. The store manager can set details such as downloadability, how such promotions may be marketed and advertised, and the like. The store manager may also set details about a grace period, which may correspond to the number of days after the original expiration that a consumer may continue with the entitlement before the good is disabled. Setting other such variables and parameters within the context of the framework will also be understood.

### Examples of Types of Promotions Implementable by the Promotion Engine Framework

While many promotions may be constructed using the promotion engine, certain groupings of promotions will be seen. In general, promotions will be seen of the form shown in FIGS. 5(A)-(B). FIG. 5(A) illustrates a number of different promotion types; FIG. 5(B) illustrates certain types, which are described in greater detail below.

### Voucher

In a general case, a store manager may create a promotion voucher 42, which if purchased allows a user to select certain items out of a group or category, or enable others to, e.g., as a gift. A promotion voucher is simply a product voucher that references a promo SKU, and generally grants the same entitlement collection, e.g., reward SKUs, that a promo SKU grants, the only difference being that the entitlement is obtained via voucher redemption instead of a purchase.

### Selective Voucher

A selective voucher 44 is a special type of voucher, and in particular is a product voucher that references a selective entitlement SKU. Such a promotion may be of the form “redeem this voucher and select 3 items from a category of 15 items”. In one implementation, a store manager may create a selective voucher, whose redemption allows a customer to choose or select a predetermined number, e.g., ‘N’, of items to receive from a group or category of items. One benefit to such a selective voucher is that customers may split the cost of the selective voucher—e.g., if a selective voucher yields three selections, one customer may receive one and their friend two of the entitlements.

### Subscription-Based Voucher

In a further case, a store manager may create a promotion similar to one of the above, but where are the same is subscription-based, such promotions being embodied as subscription-based vouchers 46.

For example, if a promotion is purchased, a certain number of items may be downloaded and enjoyed for a set number of days. After the certain number of days, the promotion may be re-purchased and the items continued to be enjoyed, or new items downloaded and played. The re-purchase may be automatic, may be after a user prompt, or may be entirely initiated by the user. As noted above, a grace period may be provided to allow access to content for a short time even after expiration.

In a specific example, the promotion may be of the form “buy this promotion and play 5 items for 30 days”, in which case each downloadable content will expire every 30 days. If a user does continue to repurchase the promotion, he or she may continue to play the downloaded items. That is, the subscription may be automatically repurchased on a periodic basis, or a user may be prompted for the same.

Numerous variations may be seen of the subscription model. Rewards may be provided after a period of consecutive repurchases, and/or vouchers may be provided to long-term subscribers for their own use or to give to their friends. A re-purchase may entitle the user to obtain a number of group Y goods or the user may be allowed to convert their entitlement (obtained by the re-purchase) to vouchers for subsequent distribution.

### Bundles

The promotion engine may also be employed to create a bundle 48 of promoted goods, which is a logical grouping of content to be sold as a single unit. In this case, if the promotion is purchased, a user gets a certain number of items for a discount or for free, e.g., at a discount of 100%.

The form of such promotions may be “buy this promotion and get N amount of items for a discount of 100%” or “buy this promotion for $25 and get five sports games”. The store manager sets the price of the promotion using the framework. Bundles may also be the subject of subscriptions, and in this case are occasionally termed “subscription packs”.

### Other Examples

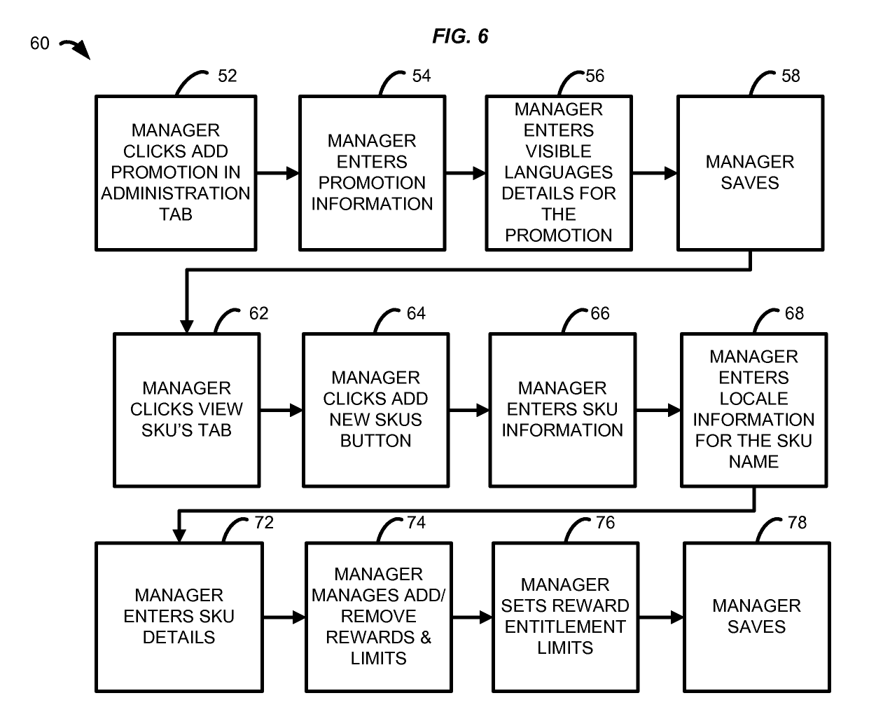

A store manager may create a promotion and may desire to select existing SKUs to be part of a redeemable reward so that a promotion such as “buy this promotion and get N downloads” is provided in a network store. Referring to FIG. 6, a flowchart 60 indicates exemplary steps that the storefront manager may employ to use the framework to create the promotion.

A first step is that a store manager may click an ADD PROMOTION button in an ADMINISTRATION page or tab (step 52). The store manager may then enter PROMOTION INFORMATION (step 54). The store manager enters various details such as VISIBLE LANGUAGES for the Promotion (step 56), the languages in which the promotion is based. If desired, the store manager may perform an action to SAVE PROMOTION (step 58). As noted above, various advantages inure where promotion and reward entities are stored as SKUs. Accordingly, a next step is that the store manager clicks the VIEW SKUs tab (step 62). The store manager may then click an ADD NEW SKU button (step 64). The store manager enters the SKU Information (step 66), including LOCALE INFORMATION for the SKU Name (step 68). The store manager enters relevant SKU DETAILS (step 72). The store manager may then manage ADD/REMOVE REWARDS AND LIMITS (step 74). For example, the store manager may add various reward entities to a promotion. The store manager may then set various REWARD ENTITLEMENT LIMITS (step 76), such as pertaining to how many times a user may take advantage of a promotion, and so on. The store manager may then SAVE PROMOTION (step 78).

### Example—Pick-N

A “Pick-N” promotion as termed herein is a goods or service entitlement that grants a user ‘N’ picks from a reward pool for purchasing a promotion SKU. In a Pick-N promotion, the user need not obtain goods for purchase per se—rather, the user may obtain access to a group of goods upon purchase of one or more prerequisite goods or services. That is, the user is given the right or entitlement to select one or more items of digital content from a group of N such items, generally (but not exclusively) where the N items are SKUs, not entitlements themselves. If there is no additional cost, the N such items are provided at a 100% item level discount.

A Pick-N promotion, also termed a “selective entitlement”, includes a promo SKU, with its corresponding SKU information (price, availability, etc.) and a “Pick-N” reward entitlement. In Pick-N promotions, the SKU that is purchased grants entitlement to the promotion, and gives the user the picks or uses that are the subject of the reward. This type of reward entitlement enables access to one or more items from a catalog of “N” SKUs. In general, a “Pick-N” promotion can be considered a promotion that grants access to a pool of content available at a discount, including at a 100% discount. In other words, the purchase of the promo SKU grants access to content, and the access may be, e.g., discounted and/or duration-based.

In the “Pick-N” case, the reward may be represented by a consumable entitlement whose usage count is decremented after the purchase of a bundle SKU. In some implementations, a “Pick-N” SKU cannot be purchased more than once while the user is still entitled to the reward entitlement, preventing the user from stacking a promotion. For example, if a promotion grants three selections over a set duration, the system does not allow the purchase of the promotion a second time until the three selections are used and/or until after the set duration. The entitlement may have an expiration or “re-cycle” date, which controls when a user can select or pick an element from the reward pool, and how long the user has access to the content or service. This “validity period” may be reflected in the license granted for each entitlement of any SKUs purchased. This enables resellers to offer rentals of content.

A Pick-N voucher or selective voucher may be provided, the same being a product voucher that is linked to a selective entitlement or Pick-N SKU. In this regard it is noted that a product voucher may add entitlements to a SKU owned by a user and in many cases is restricted by region, content rating, age limit, or the like. In the same way, a promotion may be built around the voucher, in which case the store manager may sell or otherwise market the promotion and, e.g., make the same a subscription in the manner noted above.

The group Y or reward entitlement goods may be discounted or free. If discounted, each “pick” allows a store manager to essentially offer a sale on that item. If free, the discount is set to 100%. These and other parameters for the goods may be associated with the SKU set for the product.

One benefit of such systems is that, by associating the goods with SKUs, a degree of reuse may be had of existing tools, commerce system interfaces, and storefronts. In other words, such promotion systems may remain consistent with current purchase flow and commerce system behaviors with respect to the application of individual entitlements.

The framework may be employed to create a Pick-N promotion by, e.g., modifying a category entity to group selections of N items. The category may then employ new flags indicating the root selective SKU or product that grants the selective entitlement, so that the client or user knows what to purchase if not entitled (flags may be provided that indicate eligibility for display or purchase). Client/server aspects may be modified to handle the modified category fields. Mechanisms may be reused to satisfy the requirements for selective entitlement, by modifying usage-based entitlement to enable automatic recycling of use count on a time period without the need for repurchase.

### Device Bindings

Promotions may be bound to specific platforms, game consoles, portable consoles, PCs, or the like, and the SKUs made available within reward pools may continue to honor their respective platform usability and availability. In particular, device bindings to the goods may be effected by way of modification of certain internal interfaces. For example, a portable gaming system may be tied to an entitled product by way of such an interface, and such a tying may be required by the license to the product or by other considerations.

In one corresponding method, a user may purchase a subscription on a storefront, and the user can choose games for download on their portable console. Upon purchase, the chosen games may be bound to the portable console, and the user receives a limited license to the chosen games. The license period of the chosen games may match the expiration of the subscription pack, although as noted above a grace period may be provided for the chosen games after the pack expires. The license period may also differ from the renewal period of the subscription, e.g., a title may be licensed for 60 days, and thus be available for play every 60 days, but the subscription renewal may occur every 30 days, allowing the purchaser to purchase additional titles if desired.

The device bindings in, e.g., the selective voucher scenario described above, may be such that the user can redeem the selective voucher for certain items but not others, e.g., for items on consoles but not PCs. On the other hand, the promo portion in the selective voucher need not be bound to any console nor need it have an expiration period. Of course, variations will be seen in these scenarios.

The device bindings in the selective bundle scenario described above may be similar, i.e., the user can redeem the same for certain items but not others. The playable platform depends on each reward content, and again the promo portion of the bundle product need not be bound to any console, nor need it have an expiration period.

In another implementation, users can purchase rental packs from storefronts. In this case, the same may be bound to a console, e.g., each reward SKU may be so bound, thus purchased games can then be played on the activated console. Such rental entities may have associated therewith an expiration period i.e., a time-limited license. Such a game rental service allows consumers to rent games on a recurring basis with usage constraints defined by a particular sales option, defined by the SKU and entitlement. Game rental promotions may in some implementations involve the following: a “Pick-N” promotions SKU (with constraints on cycling, selections, and duration), subscription support (for cycling), and a reward pool with a collection of reward SKUs.

When the pick count is consumed, i.e., equals zero, the rental, e.g., from a bundle pack, expires even if some of the expiration period remains. A license period of reward contents may be the same as the bundle pack. However, the license period of reward contents need not match the expiration of the bundle pack.

To implement the above, the SKU_ENTITLEMENT may have a lookup, BIND_DEVICE_FLAG, to determine the behavior purchases of DRM content made with rewards having a device-bound license. This value can essentially override binding behavior that is already specified in a DRM_CONTENT record for the content. The new column may indicate one of the following: DeviceBind, i.e., whether content purchased with the reward will be bound to a device instance; NoDeviceBind, i.e., whether content purchased with the reward will not be bound to a device instance; or NULL, i.e., an indication to defer to the binding that is specified by DRM_CONTENT, if any. The SKU may have a secondary table to allow specification of device-specific platforms to which licenses will be bound. This allows a promo to be sold whose reward can be used to purchase DRM content licensed for specific platforms. For example, a store manager could create a promo SKU and reward such that users could only use the purchased item on a particular device. In essence, the same offers platform specific promo pricing options.

Systems and methods have been described which provide a convenient framework for offering promotions. Using the framework, new promotions can be added in a convenient fashion, providing resellers with a multitude of options for packaging and distributing new and existing content and services.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Any number of processors may be employed to perform the steps of the method, and distributed computed techniques may also be used. Inputs to the application, e.g., from a plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file—storing medium. The outputs may be delivered to a user by way of a video graphics card or integrated graphics chipset coupled to a display that maybe seen by a user. Alternatively, a printer may be employed to output hard copies of the results. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or WiFi—connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method.

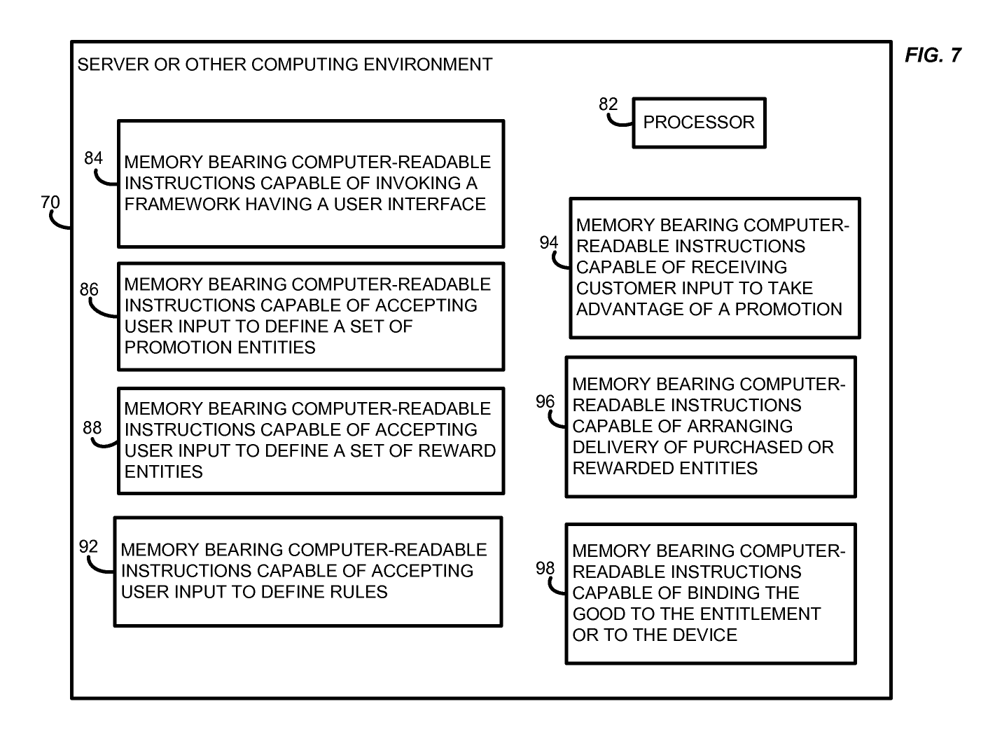

Referring to FIG. 7, a representation of one particular exemplary computing environment 70 is illustrated. The computing environment 70 includes a processor 82 and memory 84 bearing computer-readable instructions capable of invoking a framework having a user interface. The computing environment 70 further includes memory 86 bearing computer-readable instructions capable of accepting user input via the user interface to define a set of promotion entities, i.e., a promotion pool. The computing environment 70 further includes memory 88 bearing computer-readable instructions capable of accepting user input via the user interface to define a set of reward entities, i.e., a reward pool. The memories 86 and 88 may further serve to associate the promotion and reward entities with promotion and reward SKUs, respectively. The computing environment 70 further includes memory 92 bearing computer-readable instructions capable of accepting user input via the user interface to define rules for the promotion, i.e., a ruleset or rules list. The computing environment 70 further includes memory 94 bearing computer-readable instructions capable of receiving a customer input to take advantage of a promotion by the purchase of one or more promotion entities or via alternate means, e.g., as illustrated in FIG. 1(B). The computing environment 70 may further include memory 96 bearing computer-readable instructions capable of providing delivery (or arranging for delivery) of purchased goods or services (and/or rewarded goods and services). The computing environment 70 may further include memory 98 bearing computer-readable instructions capable of binding the good to the entitlement, or in some cases to the device, e.g., game console.

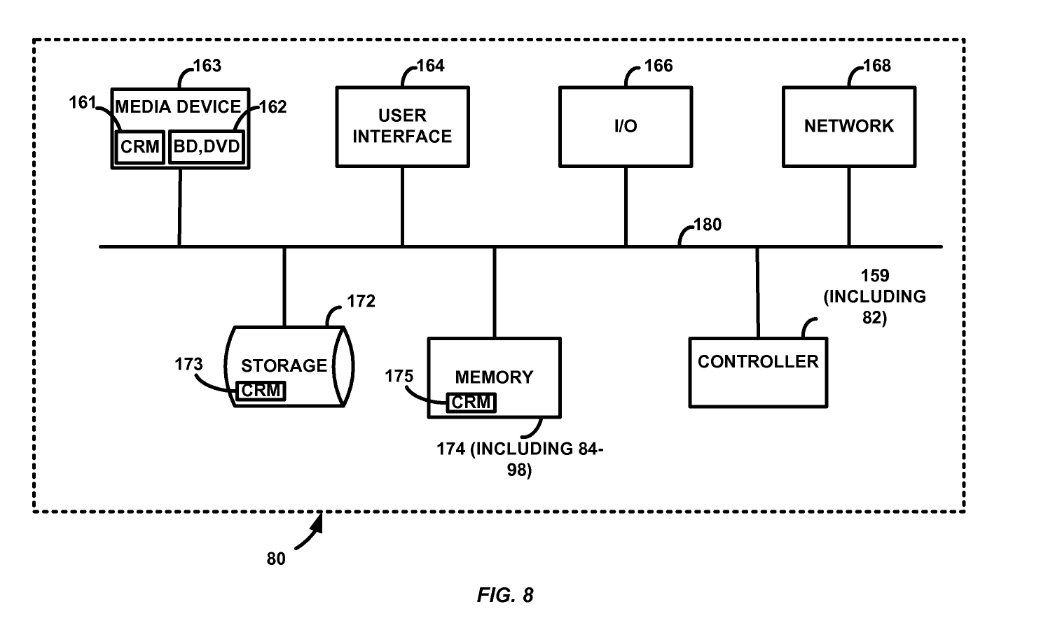

Referring to FIG. 8, a representation of another exemplary computing environment 80 is illustrated, where computing environment 80 may be representative of computing device 70 or of a server (or other computing environment) that may operate the framework.

The computing environment includes a controller 159, a memory 174, storage 172, a media device 163, a user interface 164, an input/output (I/O) interface 166, and a network interface 168. The components are interconnected by a common bus 180. Alternatively, different connection configurations can be used, such as a star pattern with the controller at the center.

The controller 159 includes a programmable processor and controls the operation of the second display and servers and their components. The controller 159 loads instructions from the memory 174 or an embedded controller memory (not shown) and executes these instructions to control the system. In its execution, the controller 159 may provide the second display control of a content playback device system as, in part, a software system. Alternatively, this service can be implemented as separate modular components in the controller 159 or the second display.

Memory 174, which may include non-transitory computer-readable memory 175, stores data temporarily for use by the other components of the second display 14i, and the same may include memories 84-94, as discussed above. In one implementation, memory 174 is implemented as RAM. In other implementations, memory 174 also includes long-term or permanent memory, such as flash memory and/or ROM.

Storage 172, which may include non-transitory computer-readable memory 173, stores data temporarily or long-term for use by other components of the second display and servers, such as for storing data used by the system. In one implementation, storage 172 is a hard disc drive or a solid state drive.

The media device 163, which may include non-transitory computer-readable memory 161, receives removable media and reads and/or writes data to the removable media. In one implementation, the media device 163 is an optical disc drive or disc burner, e.g., a writable Blu-ray® disc drive 162.

The user interface 164 includes components for accepting user input from the user of the second display, and presenting information to the user. In one implementation, the user interface 164 includes a keyboard, a mouse, audio speakers, and a display. The controller 159 uses input from the user to adjust the operation of the second display 14i.

The I/O interface 166 includes one or more I/O ports to connect to corresponding I/O devices, such as external storage or supplemental devices, e.g., a printer or a PDA. In one implementation, the ports of the I/O interface 166 include ports such as: USB ports, PCMCIA ports, serial ports, and/or parallel ports. In another implementation, the I/O interface 166 includes a wireless interface for wireless communication with external devices. These I/O interfaces may be employed to connect to one or more content playback devices.

The network interface 168 allows connections with the local network and optionally with content playback device 12 and includes a wired and/or wireless network connection, such as an RJ-45 or Ethernet connection or “WiFi” interface (802.11). Numerous other types of network connections will be understood to be possible, including WiMax, 3G or 4G, 802.15 protocols, 802.16 protocols, satellite, Bluetooth®, infrared, or the like.

Various illustrative implementations of the present invention have been described. However, one of ordinary skill in the art will recognize that additional implementations are also possible and within the scope of the present invention. For example, while storefronts have been focused on, the user may also employ implementations of the invention in numerous other ways, including offering promotions in non-commerce settings, e.g., in education or gaming As another example, besides offering specific items as rewards, the rewards may be discounts for yet other items.

Accordingly, the present invention is not limited to only those implementations described above.

1. A framework, embodied on a non-transitory computer-readable medium, for developing promotions within a network, comprising:
a. a database module, the database module including a plurality of entities, the entities representing respective goods and services;
b. a promotion pool selection module, the promotion pool selection module configured to receive a user selection of promotion entities from the database module, an aggregate of the selected promotion entities constituting a promotion pool;
c. a reward pool selection module, the reward pool selection module configured to receive a user selection of reward entities from the database module, an aggregate of the selected reward entities constituting a reward pool; and
d. a rules module, the rules module for creating rules that govern entitlement to reward entities upon purchase of promotion entities, the rules module further for determining if a purchase creates an entitlement to a selection from the reward pool.

2. The framework of claim 1, wherein at least one promotion entity and at least one reward entity are associated with a respective promotion and reward SKU.

3. The framework of claim 2, further comprising a commerce system interface, wherein the commerce system interface accesses one or more promotion or reward SKUs.

4. The framework of claim 1, wherein the promotion pool and the reward pool are partially coincident.

5. The framework of claim 1, further comprising a voucher creation module, wherein a voucher may be created that conveys an entitlement.

6. The framework of claim 5, wherein the voucher includes a coupon code.

7. The framework of claim 5, wherein the voucher creation module is configured to create a selective voucher, whereby a selective voucher is a voucher that references a selective entitlement SKU.

8. The framework of claim 7, wherein the selective entitlement SKU entitles a customer to select a predetermined number of reward entities to receive upon redemption.

9. The framework of claim 7, wherein the selective entitlement SKU is a recurring selective entitlement SKU, wherein the selective entitlement SKU renews or is reissued on a periodic basis.

10. The framework of claim 3, wherein the promotion SKU includes one or more parameters about the reward entity.

11. The framework of claim 10, wherein the one or more parameters are selected from the group consisting of: a recurrence of the promotion, a combinability of the promotion, a number of times the promotion can be consumed and a corresponding consumption counter, a SKU entitlement, and a number of selections that a user may select from the reward pool.

12. The framework of claim 3, wherein the reward SKU includes one or more parameters about the reward entity.

13. The framework of claim 12, wherein the one or more parameters are selected from the group consisting of: a scope of the reward and an amount of discount to be applied to a reward entity.

14. The framework of claim 1, wherein the rules module includes rules about how many promotion entities need be purchased to create an entitlement to one or more reward entities.

15. The framework of claim 14, wherein the rules module further includes rules about what type of promotion entities need be purchased to create an entitlement to one or more reward entities.

16. The framework of claim 15, wherein the rules module further includes rules about where the promotion entities need be purchased from to create an entitlement to one or more reward entities.

17. The framework of claim 1, further comprising a user interface, whereby a user may control the respective modules.

18. The framework of claim 1, further comprising a device bindings module, wherein a user may control to which category of device a promotion or reward entity is bound.

19. The framework of claim 1, further comprising a device bindings module, wherein a user may control to which device a promotion or reward entity is bound.

20. The framework of claim 1, wherein the promotion or reward entity constitutes a rental.

21. A non-transitory computer readable medium, comprising instructions for causing a computing device to implement the framework of claim 1.

22. A method of creating a promotion in an e-commerce system, comprising:
a. receiving a selection of promotion entities from a database, an aggregate selection constituting a promotion pool;
b. receiving a selection of reward entities from a database, an aggregate selection constituting a reward pool; and
c. developing one or more rules that govern entitlement to reward entities upon purchase of promotion entities, the rules for determining if a purchase creates an entitlement to a selection from the reward pool.

23. A non-transitory computer readable medium, comprising instructions for causing a computing device to perform the method of claim 22.
